(19) United States
(12) Patent Application Publication
(10) Pub. No.: US 2022/0416226 A1
(43) Pub. Date: Dec. 29, 2022

(54) Lithium Ion Battery and Method for Producing a Lithium Ion Battery

(71) Applicant: Bayerische Motoren Werke Aktiengesellschaft, Muenchen (DE)

(72) Inventors: Roland JUNG, Muenchen (DE); Hideki OGIHARA, Haimhausen (DE); Thomas WOEHRLE, Muenchen (DE)

(21) Appl. No.: 17/779,084

(22) PCT Filed: Nov. 9, 2020
(86) PCT No.: PCT/EP2020/081471

§ 371 Date: May 23, 2022

(30) Foreign Application Priority Data
Dec. 19, 2019 (DE) 10 2019 135 049.2

(51) Int. Cl. H01M 4/36; H01M 4/50; H01M 4/525; H01M 10/0525

(52) U.S. Cl. CPC H01M 4/364; H01M 4/502; H01M 4/525; H01M 4/366; H01M 10/0525; H01M 2004/028

(57) ABSTRACT

A lithium ion battery includes a cathode having a composite cathode active material and an anode having an anode active material. The composite cathode active material includes at least one first and one second cathode active material, wherein the second cathode active material is a compound having a spinel structure and wherein at least a lithiation degree of the first cathode active material differs from a lithiation degree of the second cathode active material. A degree of lithiation a of the first cathode active material is higher than a degree of lithiation b of the second cathode active material before electrolyte filling and before the first discharging and/or charging process of the lithium ion battery. The anode active material is pre-lithiated before the electrolyte filling and the first discharging and/or charging process of the lithium ion battery. A method for producing such a lithium ion battery is also described.

### BACKGROUND AND SUMMARY

The invention relates to a lithium ion battery and to a method for producing a lithium ion battery.

The term “lithium ion battery” is used below synonymously for all customary prior-art designations for lithium-containing galvanic elements and cells, such as, for example, lithium battery, lithium cell, lithium ion cell, lithium polymer cell, and lithium ion accumulator. The term includes, in particular, rechargeable batteries (secondary batteries). The terms “battery” and “electrochemical cell” are also utilized synonymously with the term “lithium ion battery”. The lithium ion battery may also be a solid-state battery, such as a ceramic or polymer-based solid-state battery.

A lithium ion battery has at least two different electrodes: a positive (cathode) and a negative (anode) electrode. Each of these electrodes comprises at least one active material, optionally together with additives such as electrode binders and electrical conductivity additives.

A general description relating to the lithium ion technology is found in chapter 9 (Lithium ion cell, author: Thomas Wohrle) of the “Handbuch Lithium-Ionen-Batterien” (editor: Reiner Korthauer, Springer, 2013) and also in chapter 9 (Lithium-ion cell, author: Thomas Wohrle) of the book “Lithium-Ion Batteries: Basics and Applications” (editor: Reiner Korthauer, Springer, 2018). Suitable cathode active materials are known from EP 0 017 400 B1.

In lithium ion batteries both the cathode active material and the anode active material must be capable of reversibly receiving and releasing lithium ions.

In the present state of the art, lithium ion batteries are assembled and processed in the fully uncharged state. This corresponds to a state in which the lithium ions are fully intercalated, i.e., incorporated, in the cathode, while the anode typically has no active lithium ions, these being ions amenable to reversible cycling.

In the first charging of the lithium ion battery, also known by the term “formation”, the lithium ions depart the cathode and are intercalated in the anode. This first charging entails complex events with a multiplicity of reactions occurring between the various components of the lithium ion battery.

Particularly significant in this context is the formation of an interface, also referred to as “solid electrolyte interface” or “SEI”, between active material and electrolyte on the anode. The formation of the SEI, which is also regarded as a protective layer, is attributed substantially to decomposition reactions of the electrolyte with the surface of the anode active material.

Construction of the SEI, however, requires lithium, which is subsequently no longer available for cycling in the charging and discharging process. The difference between the capacity after the first charging and the capacity after the first discharging, in relation to the charging capacity, is referred to as the formation loss and, depending on the cathode and anode active materials used, may lie within the range from about 5% to 40%.

The cathode active material must therefore be overdimensioned, in other words provided in a larger quantity, in order to achieve a desired nominal capacity of the completed lithium ion battery even after the formation loss, and this raises the costs in production and lowers the specific energy of the battery. As a consequence, there is also an increased demand for toxic metals and/or metals of limited availability that are needed for the production of the cathode active material, examples being cobalt and nickel.

From EP 3 255 714 B1 it is known practice to provide an additional lithium depot comprising a lithium alloy, in order to be able to compensate lithium losses during the formation of the cell and/or in the operation of the cell. The provision of additional components, however, implies a more complex cell construction, additional production processes with partly increased complexity, and higher costs.

For cell manufacture as known in the prior art, the lithium ion batteries are initially assembled in the uncharged state and then undergo formation. Formation is a most expensive process, requiring not only specific equipment but also compliance with exacting safety standards, concerning fire protection in particular.

### DETAILED DESCRIPTION

It is an object of the invention to provide a lithium ion battery which has a higher specific energy and a higher current-carrying capacity, and also an inexpensive method for producing such a lithium ion battery. More particularly the method for producing such a lithium ion battery is to be simpler than known methods.

The object may be achieved in accordance with the invention by means of a lithium ion battery with a cathode which comprises a composite cathode active material and an anode which comprises at least one anode active material. The composite cathode active material comprises at least one first and one second cathode active material, where the second cathode active material is a compound with spinel structure. The first cathode active material has a degree a of lithiation and the second cathode active material has a degree b of lithiation. The degree b of lithiation of the second cathode active material before the first discharging and/or charging of the lithium ion battery is lower than the degree a of lithiation of the first cathode active material. The anode active material before the first discharging and/or charging of the lithium ion battery is prelithiated.

More particularly, the degree a of lithiation of the first cathode active material before the filling of the lithium ion battery with electrolyte is lower than the degree b of lithiation of the second cathode active material. The degree b of lithiation of the second cathode active material before the filling of the lithium ion battery with electrolyte is more particularly less than 1.

The term “degree of lithiation” denotes the amount of reversibly cyclable lithium, in the form of lithium ions and/or metallic lithium, in relation to the maximum amount of reversibly cyclable lithium in the active material. The degree of lithiation is, in other words, a measure of the percentage of the maximally cyclable lithium content that is incorporated or intercalated within the structure of the active material.

A degree of lithiation of 1 here denotes a completely lithiated active material, whereas a degree of lithiation of 0 indicates a completely delithiated active material.

For example, the degree of lithiation is 1 in a stoichiometric manganese spinel LiMn₂O₄ and correspondingly is 0 for pure λ-Mn₂O₄.

The first cathode active material may consist of or comprise any of the positive active materials known in the prior art.

The first cathode active material is preferably selected from the group consisting of layered oxides, including over-lithiated oxides (OLOs), compounds with olivine structure, compounds with spinel structure, and combinations thereof.

At least with regard to the respective degree of lithiation, the first cathode active material is different from the second cathode active material.

In this sense, the first and second cathode active materials may also be selected from the same class of compound: for example, two spinels differing in lithium content and/or differing in chemical composition.

The first and second cathode active materials are, more particularly, structurally different. For example, the first cathode active material may be a layered oxide and the second cathode active material may be a compound with spinel structure. The layered oxide may comprise an over-lithiated oxide (OLO).

On the basis of its spinel structure, the second cathode active material may exhibit a lower kinetic inhibition with regard to the intercalation of lithium than the first cathode active material, particularly if the first cathode active material is a layered oxide.

The use of a second cathode active material, which before the first discharging and/or charging has a lower degree of lithiation and generally a lower kinetic inhibition to the incorporation of lithium than the first cathode active material, enables the corresponding amount of lithium ions, which after the first charging can no longer be incorporated into the first cathode active material, to depart the anode again during discharging at customary current rates, this quantity of lithium ions being incorporated in the cathode. More particularly this fraction is intercalated in the second cathode active material. As a result, it is possible to reduce the formation loss occurring during the first charging, resulting in an increased energy density or specific energy or nominal capacity of the lithium ion battery comprising a composite cathode active material of this kind.

Because, after the filling with electrolyte and more particularly during the first discharging cycle, the lithium ions are also incorporated into the second cathode active material, the ratio of the degree of lithiation of the first and second cathode active materials after the filling with electrolyte and/or after the first discharging and/or charging may differ from the initial state in the composite cathode active material. Since, however, the formation loss occurs almost exclusively during the first discharging and/or charging, the initial state of the composite cathode active material, in particular, is important for the avoidance of formation losses. The data regarding the degrees of lithiation of first and second cathode active materials in the composite cathode active material of the invention are therefore based on the state before the first discharging and/or charging and more particularly before the filling with electrolyte.

In accordance with the invention, the anode active material before the first discharging and/or charging of the lithium ion battery is prelithiated. The term “prelithiated” or “prelithiation” indicates that in the anode active material lithium is at least partly present, more particularly intercalated and/or alloyed, in the structure of the anode active material of the lithium ion battery, even before the first discharging and/or charging, more particularly before the filling with electrolyte.

The lithium used for the prelithiation is able not only to be later available as a lithium reserve in the charging and discharging cycles of the lithium ion battery but also to be utilized for the formation of an SEI even before, or during, the first discharging and/or charging of the lithium ion battery. The prelithiation is therefore able at least partly to compensate the formation losses that otherwise occur. This enables a further reduction in the quantity of the expensive and possibly toxic cathode active materials, such as cobalt and nickel. Moreover, the reactions for the formation of the SEI need not take place only during the first discharging and/or charging of the assembled lithium ion battery, but may instead be carried out at least partly during the production of the anode active material and/or the anode, more particularly after the introduction of the electrolyte filling.

The anode material in particular is prelithiated to an extent such that there is more lithium present than is needed for forming the SEI during anode production and/or during formation of the lithium ion battery. The anode active material before the first discharging and/or charging of the lithium ion battery, more particularly before the filling with electrolyte, preferably has a degree c. of lithiation of more than 0 and additionally has a stable SEI.

The anode active material is, more particularly, prelithiated substoichiometrically—that is, the degree c. of lithiation of the active material is less than 1. More particularly the degree c. of lithiation of the anode active material may be in the range from 0.01 to 0.5, preferably in the range from 0.05 to 0.30. If using graphite as anode active material, this may correspond to a composition of Li_{0.01≤x≤0.5}C₆ or Li_{0.05≤x≤0.30}C₆, respectively. If using silicon as anode active material, this may correspond to a composition of Li_{0.037≤x≤1.857}Si₁ or Li_{0.1875≤x≤1.125}Si₁, respectively.

Through the combination of a partly delithiated composite cathode active material and of an optionally substoichiometrically prelithiated anode active material, the lithium ion battery is already at least partly charged directly after assembly and is therefore immediately suitable for use.

The first discharging and/or charging may take place, accordingly, directly in the envisioned application, with the end customer, for example. Individual electrochemical cells may also be first connected to form a battery module and only then for the first time discharged and/or charged.

In this way it is possible to omit the precharge step and the formation step, in other words the first-time charging of the lithium ion battery, during the production operation, thereby shortening the production time. There is also a reduction in the current consumption involved in production and also in the extent and operation of the required production units.

The difference between the degree of lithiation of the first cathode active material and the degree of lithiation of the second cathode active material may be 0.1 or more.

Preferably, the difference between the degree of lithiation of the first cathode active material and the degree of lithiation of the second cathode active material may be 0.5 or more. The effect of this large difference in the degree of lithiation of the two cathode active materials is that, promoted kinetically, lithium can be incorporated sufficiently into the second active material. This may take place not only after the first charging but also, if the anode is prelithiated to a corresponding degree, in the first discharging prior to a first charging.

In another variant, the second cathode active material is completely delithiated. In other words, barring unavoidable impurities, there is no lithium within the second cathode active material before the first discharging and/or charging cycle of the lithium ion battery.

Partly or completely delithiated cathode active materials are available commercially or may be obtained by electrochemical extraction of lithium from completely or partly lithiated cathode active materials. Also possible is a chemical extraction of lithium from completely or partly lithiated cathode active materials wherein the lithium is leached out by means of acids, such as by means of sulfuric acid (H₂SO₄), for example.

The degree of lithiation of the composite cathode active material may be adapted to the prelithiation of the anode active material. In other words, the degree of lithiation of composite cathode active material may be lowered by the quantity of lithium utilized for the prelithiation of the anode active material. In this way the energy density or the open cell voltage of the lithium ion battery is further optimized.

According to one embodiment, the first cathode active material comprises a layered oxide.

The layered oxide of the first cathode active material may comprise nickel and cobalt; more particularly, the layered oxide may be a nickel-manganese-cobalt compound or a nickel-cobalt-aluminum compound.

The layered oxide may also comprise further metals as known in the prior art. The layered oxide more particularly may comprise doping metals, examples being magnesium, aluminum, tungsten, chromium, titanium, or combinations thereof.

In one variant, the first cathode active material is a layered transition metal oxide with α-NaCrO₂ structure. Such cathode active materials are disclosed for example in EP 0 017 400 A1.

Lithium-nickel-manganese-cobalt compounds are also known under the abbreviation NMC, and in certain cases alternatively under the technical abbreviation NCM as well. NMC-based cathode active materials are employed in particular in lithium ion batteries for vehicles. NMC as a cathode active material features an advantageous combination of desirable properties: for example, a high specific capacity, a reduced cobalt fraction, a high high-current capacity, and a high intrinsic safety, this being manifested, for example, in sufficient stability on overcharging.

NMCs may be described with the general formula unit Li_{α}NiₓMn_{y}Co_{z}O₂ with x+y+z=1, where a denotes the datum of the stoichiometric fraction of lithium and is customarily between 0.8 and 1.15. Certain stoichiometries are indicated in the literature as numerical triplets—for example, NMC 811, NMC 622, NMC 532 and NMC 111. The numerical triplet indicates the relative amount of nickel:manganese:cobalt in each case. In other words, for example, NMC 811 is a cathode active material having the general formula unit LiNi_{0.8}Mn_{0.1}Co_{0.1}O₂, i.e., with α=1. It is also possible, furthermore, to use the so-called lithium-rich and manganese-rich NMCs having the general formula unit Li_{1+ε}(NiₓMn_{y}Co_{z})_{1-ε}O₂, where F in particular is between 0.1 and 0.6, preferably between 0.2 and 0.4. These lithium-rich layered oxides are also known as over-lithiated (layered) oxides (OLOs).

In embodiments of the invention, any customary NMC can be used as first cathode active material.

An alternative possibility also is to use lithium-nickel-cobalt-aluminum compounds as first cathode active material, these being known under the abbreviation NCA; they can be described via the general formula unit Li_{α}NiₓCo_{y}Al₂O₂ with x+y+z=1, where a denotes the datum of the stoichiometric fraction of lithium and is usually between 0.80 and 1.15.

An alternative possibility also is to use lithium-cobalt compounds or lithium-nickel-cobalt compounds as first cathode active material, these being known under the abbreviation LCO or LNCO, respectively, they can be described via the general formula unit Li_{α}CoO₂ or Li_{α}NiₓCo_{y}O₂ with x+y=1, where a denotes the datum of the stoichiometric fraction of lithium and is usually between 0.80 and 1.15.

In the first cathode active material of the composite cathode active material of an embodiment of the invention, a more particularly is at least 1, with a indicating the degree of lithiation of the first cathode active material. Accordingly, the first cathode active material is in particular completely lithiated.

In another embodiment, the first cathode active material is a layered oxide, a compound with olivine structure and/or a compound with spinel structure, and the second cathode active material is a compound with spinel structure. Preferably the first cathode active material is a layered oxide and the second cathode active material is a compound with spinel structure.

The second cathode active material and optionally the first cathode active material more particularly comprise a compound with spinel structure based on manganese, more particularly based on λ-Mn₂O₄. Nonstoichiometric spinels may also be used, where lithium in the crystal structure is located at the manganese sites as well. Also suitable, furthermore, are nickel-manganese spinels, which possess a relatively high potential against lithium—for example, Li₁₋ₓNi_{0.5}Mn_{1.5}O₄ with 0≤x≤1.

Spinel compounds of these kinds feature a rapid and reversible kinetics for the incorporation of lithium ions, resulting in a higher current-carrying capacity and a better low-temperature behavior on the part of the lithium ion battery. Furthermore, compounds with spinel structure are very stable, thereby further increasing the intrinsic safety of the lithium ion battery.

The spinel compound in the delithiated state preferably contains exclusively manganese and no further toxic metals and/or metals which are not infinitely available, as may be the case for layered oxides in particular. The first and/or second cathode active material therefore has a relatively high mechanical and thermal robustness. The same is true of the lithium ion battery comprising the composite cathode active material.

λ-Mn₂O₄ can be obtained by delithiation of LiMn₂O₄, where the spinel structure of the LiMn₂O⁴ is still retained. The crystal structure of λ-Mn₂O₄ therefore corresponds to the space group number 227 (Fd3m).

λ-Mn₂O₄ is available commercially and by comparison with NMC is substantially more favorable in cost terms, far less toxic, and extensively available. Moreover, λ-Mn₂O₄ is completely compatible with common electrode binders, electrolyte compositions and conductivity additives, such as conductive carbon black, for example, and also with the common production operations for cathode active materials, such as, for example, mixing, coating, calendaring, punching, cutting, winding, stacking, and laminating operations.

The spinel compound may also comprise a spinel with cobalt and/or nickel, for example the high-voltage spinel LiNi_{0.5}Mn_{1.5}O₄.

The spinel compound may be used in a particle size in the 1 to 35 μm range, preferably from 4 to 20 μm. Such particle sizes are ideally suitable for the blending of the spinel compound with further particles of the first and/or second cathode active material, especially with NMC. This allows a uniform and highly compacted composite cathode electrode to be obtained.

The second cathode active material with spinel structure more particularly has a degree b of lithiation in the 0 to 0.9 range, preferably in the 0 to 0.5 range. The spinel compound of the second cathode active material may, for example, be described with the general formula unit Li_{β}Mn₂O₄.

The first cathode active material may be a compound with olivine structure based on iron, based on iron and manganese, or based on cobalt and/or nickel.

The compound with olivine structure is more particularly iron phosphate, iron manganese phosphate, iron cobalt phosphate, iron manganese cobalt phosphate, manganese cobalt phosphate, cobalt phosphate, nickel phosphate, cobalt nickel phosphate, iron nickel phosphate, iron manganese nickel phosphate, manganese nickel phosphate, nickel phosphate, or combinations thereof. The compound with olivine structure may also be each of the stated substances in conjunction with lithium—for example, lithium iron phosphate.

The difference between the degree a of lithiation of the first cathode active material and the degree b of lithiation of the second cathode active material may be at least 0.1, preferably at least 0.5.

The weight fraction of the second cathode active material is preferably lower than the weight fraction of the first cathode active material, based on the total weight of the composite cathode active material.

In principle, however, the ratio of the weight fractions of the first and second cathode active materials may be selected arbitrarily.

The second cathode active material is present preferably in a fraction of 1 to 50 wt %, more preferably of 5 to 25 wt %, based on the total weight of the first and second cathode active materials.

The second cathode active material may in particular be selected such that it enables sufficiently rapid kinetics of lithium intercalation. Rapid kinetics, however, is typically associated with a lower specific energy of the second cathode active material. By using a lower weight fraction of the second cathode active material, sufficient improved kinetics is achieved without a disproportionate reduction by the composite cathode active material in the specific energy achievable overall.

The anode active material may be selected from the group consisting of carbon-containing materials, silicon, silicon suboxide, silicon alloys, aluminum alloys, indium, indium alloys, tin, tin alloys, cobalt alloys, and mixtures thereof. Preferably the anode active material is selected from the group consisting of synthetic graphite, natural graphite, graphene, mesocarbon, doped carbon, hard carbon, soft carbon, fullerene, silicon-carbon composite, silicon, surface-coated silicon, silicon suboxide, silicon alloys, lithium, aluminum alloys, indium, tin alloys, cobalt alloys, and mixtures thereof.

Anode active materials suitable in principle are all those known from the prior art, including, for example, niobium pentoxide, titanium dioxide, titanates such as lithium titanate (Li₄Ti₅O₁₂), tin dioxide, lithium, lithium alloys and/or mixtures thereof.

Where the anode active material already contains lithium which does not participate in the cycling, in other words, is not active lithium, this fraction of lithium may be considered in the invention not to be a constituent of the prelithiation. In other words, this fraction of lithium has no effect on the degree b of lithiation of the second active material.

In addition to the anode active material, the anode may comprise further components and additives, such as, for example, a carrier, a binder and/or an electrical conductivity improver. As further components and additives, it is possible to use all customary materials and compounds known in the prior art.

In one variant, the anode active material before the first discharging and/or charging of the lithium ion battery is prelithiated to an extent such that the assembled lithium ion battery before the first discharging and/or charging has a state of charge (SoC) in the range from 1% to 30%, preferably from 3% to 25%, more preferably from 5% to 20%.

The SoC indicates the capacity of the lithium ion battery that is still available, in relation to the maximum capacity of the lithium ion battery, and may be determined easily by way, for example, of the voltage and/or the current flow of the lithium ion battery.

The quantity of lithium which must be used for the prelithiation of the anode active material in order to achieve a particular SoC before the first discharging and/or charging of the lithium ion battery is dependent on whether an SEI is already formed on the anode active material before the first discharging and/or charging of the lithium ion battery. If this is the case, then the anode active material must be prelithiated to an extent such that the added lithium is sufficient both for forming the SEI and for achieving the corresponding capacity. The quantity of lithium needed for forming the SEI may be estimated on the basis of the anode active materials used.

The SoC of the lithium ion battery before the first discharging and/or charging, however, is dependent not only on the prelithiation of the anode active material, but also on the delithiation of the composite cathode active material. The anode active material can at least be prelithiated to an extent such as to compensate the missing lithium in the composite cathode active material. More particularly the anode active material may also be prelithiated to an extent such as to result in a lithium excess in the lithium ion battery, but at the same time in an SoC within the above-stated ranges before the first discharging and/or charging of the lithium ion battery.

Between the cathode and the anode, the lithium ion battery of the invention comprises a separator which separates the two electrodes from one another. The separator is transmissive for lithium ions but a nonconductor for electrons.

Separators used may be polymers, more particularly a polymer selected from the group consisting of polyesters, more particularly polyethylene terephthalate, polyolefins, more particularly polyethylene and/or polypropylene, polyacrylonitriles, polyvinylidene fluoride, polyvinylidene-hexafluoropropylene, polyetherimide, polyimide, aramid, polyether, polyether ketone or mixtures thereof. Additionally, the separator may optionally be coated with ceramic material, such as with Al₂O₃, for example.

The lithium ion battery further comprises an electrolyte, which is conductive for lithium ions and which may be either a solid electrolyte or a liquid which comprises a solvent and at least one conductive lithium salt dissolved therein, such as lithium hexafluorophosphate (LiPF₆), for example.

The solvent is preferably inert. Suitable solvents are, for example, organic solvents such as ethylene carbonate, propylene carbonate, butylene carbonate, dimethyl carbonate, diethyl carbonate, ethyl methyl carbonate, fluoroethylene carbonate (FEC), sulfolanes, 2-methyltetrahydrofuran, acetonitrile, and 1,3-dioxolane.

Ionic liquids may also be used as solvents. Such ionic liquids contain exclusively ions. Preferred cations, which in particular may be alkylated cations, are imidazolium, pyridinium, pyrrolidinium, guanidinium, uranium, thiuronium, piperidinium, morpholinium, sulfonium, ammonium, and phosphonium cations. Examples of anions which can be used are halide, tetrafluoroborate, trifluoroacetate, triflate, hexafluorophosphate, phosphinate, and tosylate anions.

Illustrative ionic liquids include the following: N-methyl-N-propylpiperidinium bis(trifluoromethylsulfonyl)imide, N-methyl-N-butylpyrrolidinium bis(trifluoromethyl-sulfonyl)imide, N-butyl-N-trimethylammonium bis(trifluoromethylsulfonyl)imide, triethylsulfonium bis(trifluoromethylsulfonyl)imide, and N,N-diethyl-N-methyl-N-(2-methoxyethyl)ammonium bis(trifluoromethylsulfonyl)imide.

In one variant, two or more of the above-stated liquids may be used.

Preferred conductive salts are lithium salts which contain inert anions and which preferably are not toxic. Particularly suitable lithium salts are lithium hexafluorophosphate (LiPF₆), lithium tetrafluoroborate (LiBF₄), and mixtures of these salts.

The separator may be impregnated with the lithium salt electrolyte or wetted therewith if the electrolyte is liquid.

The lithium ion battery of the invention may be provided in particular in a motor vehicle or a portable device. The portable device may be, more particularly, a smart phone, an electrical tool or power tool, a tablet or a wearable.

The object of the invention may further be achieved by a method for producing a lithium ion battery, comprising the following steps: first of all, a composite cathode active material is provided by mixing at least a first cathode active material and a second cathode active material, where the second cathode active material is a compound with spinel structure. The first cathode active material has a degree a of lithiation and the second cathode active material has a degree b of lithiation. The degree b of lithiation of the second cathode active material is less than the degree a of lithiation of the first cathode active material. The composite cathode active material is subsequently installed in a cathode and the anode active material in an anode, and a lithium ion battery is produced using the cathode and the anode. The anode active material is prelithiated before or after installation of the anode active material in an anode.

The individual constituents of the lithium ion battery are fabricated in particular from the materials described above.

Accordingly, the lithium ion battery described above is obtainable in particular by the method of the invention.

The anode active material may be prelithiated in particular by the techniques known in the prior art for producing lithium intercalation compounds or alloys.

For example, a mixture of the anode active material with metallic lithium may be produced. The mixture of anode active material may subsequently be stored for a period of up to two weeks, preferably of up to one week, more preferably of up to two days. In this period this lithium is able to be incorporated into the anode active material, and so a prelithiated anode active material is obtained.

In one variant, the prelithiation of the anode active material may be accomplished by combining the anode active material with a lithium precursor and subsequently reacting the lithium precursor to form lithium.

In another variant, the prelithiation of the anode active material may be accomplished by injecting lithium into the anode active material and/or the anode.

By storing the anode in an electrolyte over a predetermined period of, for example, 2 minutes to 14 days it is possible to construct a stable SEI on the anode.

Lastly, it is possible to carry out the prelithiation of the anode active material by electrochemically treating the anode active material, installed to form an anode, in a lithium-containing electrolyte. In this way the SEI can be formed on the anode during the prelithiation process itself. Storage of the anode in the electrolyte allows the SEI to be completed further.

Further advantages and properties of the invention are apparent from the following description and the examples, which are to be understood not in any limiting sense.

Table 1 lists the substances and materials used in the examples.

TABLE 1
Substances and materials used.

| | Description | Manufacturer |
|---|---|---|
| NMC 811 | LiNi_{0.8}Mn_{0.1}Co_{0.1}O₂ cathode | BASF |
| | active material | |
| | (fully lithiated) | |
| λ-Mn₂O₄ | Cathode active material | BMW Group, |
| | (fully delithiated) | laboratory |
| | | production |
| PVdF | Polyvinylidene fluoride, | Solvay |
| | binder | |
| NMP (electronic | N-Methyl-2-pyrrolidone | BASF |
| grade) | carrier solvent | |
| Aluminum carrier | Carrier foil for cathode | HYDRO |
| foil | | Aluminium |
| Natural graphite | Anode active material | Kropfmühl |
| SBR | Styrene-butadiene rubber, | JSR Micro |
| | binder | |
| CMC | Carboxymethylcellulose, | Nippon Paper |
| | binder | Chemical |
| Super C65 (carbon | Conductivity additive | Imerys |
| black) | | |
| Copper carrier foil | Carrier foil for anode | Circuit-Foil |
| | | (Luxemburg) |
| Lithium | Prelithiating agent | FMC (USA) |
| Celgard Separator | Separator (25 μm) of | Celgard (USA) |
| 2500 | polypropylene (PP) | |
| Liquid electrolyte, | Liquid electrolyte with | BASF |
| comprising a | conductive lithium salt | |
| solution of LiPF₆ in | | |
| organic carbonates | | |
| (e.g., ethylene | | |
| carbonate (EC), | | |
| diethylene | | |
| carbonate (DEC)) | | |
| Aluminum composite | Packaging film for the | Showa (Japan) |
| film | cell | |

### Example 1 (Reference Example)

A mixture of 94 wt % NMC 811, 3 wt % PVdF, and 3 wt % conductive carbon black is suspended in NMP at 20° C. using a dissolver mixer with high shear. A homogeneous coating material is obtained, which is knife-coated out onto an aluminum carrier foil rolled to 15 μm. After the NMP has been stripped off, a coherent cathode film is obtained with a surface weight of 22.0 mg/cm².

Analogously an anode coating material with a composition of 94 wt % natural graphite, 2 wt % SBR, 2 wt % CMC, and 2 wt % Super C65 is produced and is applied to a 10 m rolled copper carrier foil. The anode film thus produced has a surface weight of 12.2 mg/cm².

The cathode with the cathode film is installed, using an anode with the anode film, a separator (25 μm) made of polypropylene (PP), and a liquid electrolyte as a 1 M solution of LiPF₆ in EC/DMC (3:7 w/w), to form an electrochemical cell with an active electrode area of 25 cm², and this cell is packaged into highly finished composite aluminum foil (thickness: 0.12 mm) and sealed. The result is a pouch cell with external dimensions of about 0.5 mm×6.4 mm×4.3 mm.

The cell is charged for the first time to 4.2 V (C/10) and subsequently discharged to 2.8 V at C/10.

The capacity of the first charge is 111 mAh and the capacity of first discharge is 100 mAh. This results in a formation loss of around 10% for the complete cell. This corresponds to an anticipated formation loss of around 10% when using natural graphite as anode active material.

### Example 2 (Inventive Lithium Ion Battery)

A mixture of 76.5 wt % NMC 811, 17.5 wt % λ-Mn₂O₄, 3 wt % PVdF, and 3 wt % conductive carbon black is suspended in NMP at 20° C. using a mixing apparatus with high shear. A homogeneous coating material is obtained, which is knife-coated out onto an aluminum collector-carrier foil rolled to 15 μm. After the NMP has been stripped off, a cathode film is obtained with a surface weight of 22.4 mg/cm².

The NMC 811 first cathode active material used has a degree a of lithiation of 1, and the λ-Mn₂O₄ second cathode active material used has a degree b of lithiation of 0.

Analogously an anode coating material with a composition of 94 wt % natural graphite, 2 wt % SBR, 2 wt % CMC, and 2 wt % Super C65 is produced and is applied to a 10 μm rolled copper carrier foil. The anode film thus produced has a surface weight of 12.2 mg/cm².

Prior to cell assembly, this anode film is prelithiated with 19 mAh of lithium. About 11 mAh of this lithium is used in constructing an SEI protective layer, and about 8 mAh of lithium are intercalated into the graphite. This gives the natural graphite a composition of Li_{0.08}C₆, and hence it has a degree γ of lithiation of 0.08.

20 mAh of lithium correspond to 0.75 mmol or 5.2 mg of lithium.

The cathode with the cathode film is installed, using an anode with the anode film, a separator (25 μm), and an electrolyte as a 1 M solution of LiPF₆ in EC/DMC (3:7 w/w), to form an electrochemical cell with an active electrode area of 25 cm², and this cell is packaged into composite aluminum foil (thickness: 0.12 mm) and sealed. The result is a pouch cell with external dimensions of about 0.5 mm×6.4 mm×4.3 mm.

After the metering of the electrolyte and the final sealing of the inventive cell, it has an open voltage of around 3 to 3.5 V, resulting from the potential difference of the partially delithiated cathode and of the prelithiated anode. The nominal capacity of the lithium ion battery is 100 mAh, and so directly after production the lithium ion battery has a state of charge (SoC) of 8%.

The cell is charged for the first time to 4.2 V (C/10) and subsequently discharged to 2.8 V at C/10. Since after assembly and activation with liquid electrolyte the cell already possesses an SoC of 8%, a charge of 92 mAh is observed on further formation with C/10, while the first C/10 discharge is at 100 mAh.

The inventive lithium ion battery correspondingly has a capacity matching that of the reference example.

### Comparison of the Examples

The use of the composite cathode active material comprising NMC 811 and λ-Mn₂O₄ (example 2) in the cathode of the lithium ion battery reduces the use of highly costly NMC 811 relative to the reference example. It has emerged that 20.8% less highly costly NMC 811 is used in the inventive cell and can instead be substituted by the use of λ-Mn₂O₄.

The increase in the surface weight of the cathode film in example 2 by comparison with the reference example (22.4 mg/cm² instead of 22.0 mg/cm²) comes about as a result of a difference in cathode composition with λ-Mn₂O₄, in order to be able to achieve the same reversible area capacity of the lithium ion battery during the first discharging. The corresponding increase in the total weight of the composite cathode active material occurs merely due to the cost-effective and non-toxic λ-Mn₂O₄.

The lithium ion batteries of the invention are not limited to graphite as anode active material; advantageously, it is also possible to utilize silicon-based anode active materials or other anode active materials known in the prior art.

As an anode with prelithiated anode active material and a partially delithiated composite cathode active material are used for producing the lithium ion battery, the lithium ion battery is able to have a state of charge (SoC) already in the range from 1 to 30% immediately after the production step, before a first discharging and/or charging.

1-11. (canceled)

12. A lithium ion battery comprising:
a cathode comprising a composite cathode active material including at least one first cathode active material and at least one second cathode active material; and
an anode comprising an anode active material,
wherein the second cathode active material comprises a compound with spinel structure,
wherein the first cathode active material has a degree a of lithiation and the second cathode active material has a degree b of lithiation,
wherein, before a first discharging and/or charging of the lithium ion battery, the degree b of lithiation of the second cathode active material is lower than the degree a of lithiation of the first cathode active material, and
wherein, before the first discharging and/or charging of the lithium ion battery, the anode active material is prelithiated.

13. The lithium ion battery according to claim 12, wherein the first cathode active material is selected from the group consisting of: a layered oxide, including an over-lithiated oxide (OLO), a compound with olivine structure, a compound with spinel structure, and combinations thereof.

14. The lithium ion battery according to claim 12, wherein a difference between the degree of lithiation of the first cathode active material and the degree of lithiation of the second cathode active material is 0.1 or more.

15. The lithium ion battery according to claim 14, wherein the difference is 0.5 or more.

16. The lithium ion battery according to claim 13, wherein the layered oxide comprises nickel and cobalt.

17. The lithium ion battery according to claim 16, wherein the layered oxide comprises a nickel-cobalt-manganese compound or a nickel-cobalt-aluminum compound.

18. The lithium ion battery according to claim 12, wherein the compound with the spinel structure comprises a compound including manganese.

19. The lithium ion battery according to claim 18, wherein the compound with the spinel structure comprises λ-Mn₂O₄.

20. The lithium ion battery according to claim 12, wherein a weight fraction of the second cathode active material is lower than a weight fraction of the first cathode active material, based on a total weight of the composite cathode active material.

21. The lithium ion battery according to claim 12, wherein the anode active material is selected from the group consisting of: carbon-containing material, silicon, silicon suboxide, silicon alloy, aluminum alloy, indium, indium alloy, tin, tin alloy, cobalt alloy, and mixtures thereof.

22. The lithium ion battery according to claim 12, wherein the anode active material is selected from the group consisting of: synthetic graphite, natural graphite, graphene, mesocarbon, doped carbon, hard carbon, soft carbon, fullerene, silicon-carbon composite, silicon, surface-coated silicon, silicon suboxide, silicon alloy, lithium, aluminum alloy, indium, tin alloy, cobalt alloy, and mixtures thereof.

23. The lithium ion battery according to claim 12, wherein the anode active material before the first discharge and/or charging of the lithium ion battery is prelithiated to an extent such that the lithium ion battery before the first discharging and/or charging has a state of charge (SoC) in a range from 1% to 30%.

24. The lithium ion battery according to claim 23, wherein the SoC is in the range from 3% to 25%.

25. The lithium ion battery according to claim 24, wherein the SoC is in the range from 5% to 20%.

26. A method for producing a lithium ion battery, the method comprising:
providing a composite cathode active material by mixing a first cathode active material and a second cathode active material, the second cathode active material comprising a compound with spinel structure, the first cathode active material having a degree a of lithiation and the second cathode active material having a degree b of lithiation, wherein the degree b of lithiation of the second cathode active material is less than the degree a of lithiation of the first cathode active material;
providing an anode active material;
installing the composite cathode active material in a cathode and the anode active material in an anode; and
producing a lithium ion battery using the cathode and the anode;
wherein the anode active material is prelithiated before or after the installation of the anode active material in the anode.

27. The method according to claim 26, further comprising providing the anode with a solid electrolyte interface (SEI) before producing the lithium ion battery.

28. The method according to claim 26, wherein, immediately after producing the lithium ion battery and before a first discharging and/or charging of the lithium ion battery, the lithium ion battery has a state of charge (SoC) in a range from 1% to 30%.

29. The method according to claim 26, wherein the anode active material is prelithiated substoichiometrically, a degree of y of lithiation of the anode active material being less than 1.

30. The method according to claim 26, wherein the first cathode active material comprises a spinel compound differing in lithium content and/or differing in chemical composition from that of the second cathode active material.

31. The method according to claim 26, wherein the first cathode active material comprises a layered oxide.
